(19) United States
(12) Patent Application Publication
(10) Pub. No.: US 2015/0371420 A1
(43) Pub. Date: Dec. 24, 2015

(54) SYSTEMS AND METHODS FOR EXTENDING A FIELD OF VIEW OF MEDICAL IMAGES

(71) Applicant: Samsung Electronics Co., Ltd., Gyeonggi-do (KR)

(72) Inventors: Ido YERUSHALMY, Tel-Aviv (IL); Rebecca NATAF, Tel-Aviv (IL); Gavriel SPEYER, Ramat-Gan (IL); Amir SHAHAM, Givat Shmuel (IL); Alon FLEIDER, ModiIn (IL)

(21) Appl. No.: 14/308,721

(22) Filed: Jun. 19, 2014

(51) Int. Cl. G06T 11/60; G06T 7/00; G06T 5/00; G06T 5/50

(52) U.S. Cl. CPC G06T 11/60; G06T 5/50; G06T 7/003; G06T 5/002; G06T 2207/20221; G06T 2210/41; G06T 2207/20192

(57) ABSTRACT

There is provided a computer-implemented method of calculating an extended field of view (EFOV) from medical images, comprising: receiving multiple registered acquired medical images of a patient, the medical images having multiple imaging artifacts based on the medical imaging modality acquiring the medical images; analyzing the multiple medical images to identify locations of the multiple imaging artifacts within the medical images; calculating multiple multi-planar stitching surfaces such that seams connecting therebetween are outside the boundaries of the multiple imaging artifacts; and providing an extended field of view (EFOV) image having un-edited imaging artifacts from all stitched medical images.

### BACKGROUND

The present invention, in some embodiments thereof, relates to systems and methods for image processing and, more specifically, but not exclusively, to systems and methods for stitching medical images.

Medical imaging is an important tool for diagnosis of various illnesses. Imaging modalities include, for example, computed tomography (CT), magnetic resonance imaging (MRI), microscopy, ultrasound (US) and the like. Each modality is limited by a given Field of View (FOV) which may arise from different physical constraints. CT and MRI, for example, may be limited by bed travel-length. 3D ultrasound (US) transducers in general, and cardiac transducers in particular, suffer from a relatively small FOV due to technological limitations. In ultrasound machines, spatial resolution depends on the beam steering angle, which allows for the field of view to be enlarged at the expense of spatial resolution.

### SUMMARY

According to an aspect of some embodiments of the present invention there is provided a computer-implemented method of calculating an extended field of view (EFOV) from medical images, comprising: receiving multiple registered acquired medical images of a patient, the medical images having multiple imaging artifacts based on the medical imaging modality acquiring the medical images; analyzing the multiple medical images to identify locations of the multiple imaging artifacts within the medical images; calculating multiple multi-planar stitching surfaces such that seams connecting therebetween are outside the boundaries of the multiple imaging artifacts; and providing an extended field of view (EFOV) image having un-edited imaging artifacts from all stitched medical images.

Optionally, the method further comprises stitching the medical images based on the identified stitching surfaces, each side of the stitching surfaces having retained original pixel values from one of the medical images. Optionally, the method further comprises calculating a binary pixel map for each respective medical image based on the selected pixels on either side of the stitching surface, and combining the medical images based on the respective binary pixel maps to generate the EFOV image, wherein the binary pixel maps are blended in a neighborhood of a stitching seam to decrease seam visibility. Optionally, pixels having a high intensity difference between respective medical images are not blended to conserve details and edge sharpness.

Optionally, identify locations comprises calculating a validity value per pixel of the medical images based on the probability of each identified artifact being located at each respective pixel, and calculating the multiple stitching surfaces based on the validity value, such that pixels more likely to be artifacts have reduced boundary crossing by the multiple stitching surfaces. Optionally, the method further comprises selecting pixels within an overlapping region for stitching on each side of the stitching surfaces based on analysis of the validity of each pixel in the overlapping region with each respective validity map of each respective medical image.

Optionally, the method further comprises adding non-overlapping regions of each respective medical image to the overlapping region such that the largest possible EFOV image is generated from the received images.

Optionally, the method further comprises: calculating an overlapping region of the medical images; calculating a global validity value for each medical image based on the calculated validity value per pixel located within the overlapping region; selecting a dominant medical image based on relative calculated global validity values of respective medical images; and applying gain correction to other non-dominant medical images with lower validity to match the dominant image, so that the medical images have similar global intensities. Optionally, applying gain correction further comprises: identifying valid sub-regions within the overlapping region based on the calculated validity value per pixel relative to a threshold value, the sub-regions being valid in each respective medical image of the overlapping region; and manipulating pixel intensities of each identified valid sub-region based on a global matching of the identified sub-regions, and adjusting other sub-regions in proportion to the calculated validity value based on the global matching, so that less valid regions are adjusted less.

Optionally, calculating multiple stitching surfaces further comprises calculating the multiple stitching surfaces at neighborhoods of the stitching surfaces having high similarly and low resolution at each respective medical image, to reduce visibility of a stitching seam based on the stitching surfaces.

Optionally, calculating multiple stitching surfaces further comprises calculating the multiple stitching surfaces at pixels of an overlap region of the medical images having high similarity between pixels of respective medical images, to reduce visibility of a stitching seam based on the stitching surfaces. Optionally, the method further comprises calculating a similarity map of the overlap region denoting pixel similarity between respective medical images based on a similarity metric including at least one member of a group consisting of relative pixel intensity between the medical images, the probability of the pixel being the artifact wherein higher artifact probability denotes a lower similarity, and similarity of low resolution between the medical images. Optionally, the method further comprises segmenting the similarity map to unify regions which are the least similar and identify borderlines where the medical images are the most similar. Optionally, calculating the multiple stitching surfaces further comprises calculating the multiple stitching surfaces based on a minimum cut to a source-sink flow graph calculated from the segmented similarity map, wherein a weight value between two vertices representing the artifact is selected to prevent crossing of the artifact zone by the stitching surfaces, the minimum cut denoting the lowest total sum of the weight values.

Optionally, the acquired medical images are ultrasound (US) images, and the multiple artifacts include at least one member of a group consisting of: speckles, shadows, and multi line acquisition (MLA) seams, or the acquired medical images are computed tomography (CT) images, and the multiple artifacts include at least one member of a group consisting of: beam hardening, metal artifacts, and photon starvation.

Optionally, the multiple stitching surfaces are calculated so that the stitched medical images form the EFOV image as large as possible based on the received images having arbitrary shape and geometry.

Optionally, the received medical images have a dimension selected from a group consisting of: two dimension (2D), three dimension (3D), and four dimension (4D).

According to an aspect of some embodiments of the present invention there is provided a system for calculating an extended field of view from medical images, comprising: a processor; and a memory in electrical communication with the processor, the memory having stored thereon: an interface for receiving multiple registered acquired medical images of a patient, the medical images having multiple imaging artifacts based on the medical imaging modality acquiring the medical images; an analysis module for analyzing the multiple medical images to identify locations of the multiple imaging artifacts within the medical images; a stitching surface module for calculating multiple multi-planar stitching surfaces such that seams connecting therebetween are outside the boundaries of the multiple imaging artifacts; and wherein the interface provides an extended field of view image having un-edited imaging artifacts from all stitched medical images.

Optionally, the system further comprises a stitching module for stitching the medical images based on the identified stitching surfaces, each side of the stitching surfaces having retained original pixel values from one of the medical images.

Optionally, the received medical images are dynamic four dimensional US images, and the stitching surfaces comprise stitching hyper-surfaces, or the received medical images are multi-channel images, and the EFOV is created from stitching the images with respect to all data channels.

According to an aspect of some embodiments of the present invention there is provided a computer program product for computing an extended field of view from medical images, the computer program product comprising: one or more non-transitory computer-readable storage mediums, and program instructions stored on at least one of the one or more storage mediums, the program instructions comprising: program instructions for receiving multiple registered acquired medical images of a patient, the medical images having multiple imaging artifacts based on the medical imaging modality acquiring the medical images; program instructions for analyzing the multiple medical images to identify locations of the multiple imaging artifacts within the medical images; program instructions for calculating multiple multi-planar stitching surfaces such that seams connecting therebetween are outside the boundaries of the multiple imaging artifacts; and program instructions for providing an extended field of view (EFOV) image having un-edited imaging artifacts from all stitched medical images.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a computerized method of stitching medical images to form an EFOV image, in accordance with some embodiments of the present invention;

FIG. 2 is a block diagram of an exemplary system for stitching medical images to form an EFOV image, in accordance with some embodiments of the present invention;

FIG. 3 is a schematic diagram depicting an exemplary case of shadowing by a sphere, to help understand embodiments of the present invention;

FIG. 4 is a graph depicting intensity measurements obtained from backscattered US, to help understand some embodiments of the present invention;

FIG. 5 is a flowchart of a computer-implemented method for performing additional pre-processing based on the received medical images, in accordance with some embodiments of the present invention;

FIG. 6 is a set of exemplary US images depicting overlapping regions, in accordance with some embodiments of the present invention;

FIG. 7 is an exemplary computer-implemented method for calculating stitching surface(s) for the received medical images, in accordance with some embodiments of the present invention;

FIG. 8 is a schematic diagram illustrating erroneous and correct selection of stitching surfaces, to help understand some embodiments of the present invention;

FIG. 9 is an exemplary similarity map, in accordance with some embodiments of the present invention;

FIG. 10 is an exemplary image of a segmentation map, in accordance with some embodiments of the present invention;

FIG. 11 is an exemplary graph, in accordance with some embodiments of the present invention;

FIG. 12 is a schematic of a segmented map and a corresponding graph, in accordance with some embodiments of the present invention;

FIG. 13 is an exemplary graph with corresponding calculated cut, in accordance with some embodiments of the present invention;

FIG. 14 is a flowchart of an exemplary computer-implemented method of stitching the received images, in accordance with some embodiments of the present invention;

FIG. 15 is an image with selected pixels on each side of the stitching surface, in accordance with some embodiments of the present invention;

FIG. 16 is a schematic of an overlapping region and a non-overlapping region for adding to the overlapping region, in segment map form and in a corresponding graph form, in accordance with some embodiments of the present invention;

FIG. 17 is an exemplary weight map, in accordance with some embodiments of the present invention; and

FIG. 18 is an EFOV image, in accordance with some embodiments of the present invention.

### DETAILED DESCRIPTION

The present invention, in some embodiments thereof, relates to systems and methods for image processing and, more specifically, but not exclusively, to systems and methods for stitching medical images.

As defined herein, the term imaging artifacts means imaging artifacts present in medical images related to the nature of the medical imaging modality itself. For example, the underlying physics of the energy transmission and/or interaction, data acquisition errors, assumptions of the medical imaging modalities which may be incorrect in certain situations, and/or other causes. Such imaging artifacts are not present in other types of images, such as natural images obtained by a camera based on visible light. Radiologists learn to recognize some of these artifacts to avoid mistaking them for actual pathology. Radiologists learn to read medical images having such artifacts, and may come to expect the artifacts in certain situations.

An aspect of some embodiments of the present invention relates to systems and/or methods for calculating an extended field of view (EFOV) image from two or more medical images having imaging artifacts, based on multiple stitching surfaces having seams that connect between the stitching surfaces, the seams being outside of the boundaries of the imaging artifacts. The stitching surfaces avoid intersecting the imaging artifacts. Statistically, these stitching surfaces generally (or always) do not cross through the artifacts. It is noted that some crossing may be inevitable, and/or some crossing may be tolerated and/or selected, such as to improve overall quality of the image. The stitching surface may be calculated to be located a distance away from each artifact, and/or outside the boundary of each artifact, so that the stitching surface avoids intersecting the artifacts, for example, one or several pixels away from the boundary of the artifact. The EFOV is generated having un-edited imaging artifacts from all stitched medical images. In this manner, new artifacts, such as US related artifacts including speckles, shadows and multiple line acquisition seams, are not generated by splitting of existing artifacts and/or existing artifacts may be preserved. Inventors realized that retaining the imaging artifacts in their original form prevents or reduces the risk of error of diagnosis by physicians in some or all cases. Radiologists are trained to read images having imaging artifacts and therefore expect certain artifacts. Removal and/or tampering with the imaging artifacts during image stitching, may create stitching artifacts which confuse the radiologists which are not trained to detect them and/or cause an error in reading the medical image, which may lead to an error in diagnosis. The systems and/or methods described herein preserve the imaging artifacts so that the artifacts are naturally incorporated into the final stitched image. The methods and/or systems described herein maintain existing imaging artifacts and/or may avoid formation of new artifacts during the EFOV formation process, which may help radiologists read the EFOV with the same certainty related to the artifacts as compared to reading the separate medical images.

Different medical imaging modalities may have different artifacts unique to each imaging modality. The systems and/or methods described herein are based on the unique artifacts of each imaging modality. For example, ultrasound (US) artifacts include one or more of: speckles (which may dominate large portions of the image), shadowing, multi line acquisition (MLA) artifacts, limited focal zone, and/or other artifacts. For example, computed tomography (CT) artifacts include one or more of: beam hardening, metal artifacts, photon starvation (i.e., noise), and/or other artifacts.

Optionally, the location of the artifacts within the medical images is denoted by a calculated validity value, optionally a validity probability value. The validity probability value may be calculated, for example, per pixel, per group of pixels, per image feature, or other methods. The validity probability value is based on the probability of a certain pixel (or image feature) being an artifact. Pixels more likely to be artifacts are avoided during calculation of the stitching surface, as part of an overall effort to minimize crossing pixels with low validity.

Optionally, the medical images are stitched to form the EFOV by selecting and retaining original pixel values (for example, intensity values), from respective medical images on respective sides of the stitching surface. The original pixel values may include corrected pixel values. The data on each side of the stitching surface is authentic and is obtained from only one of the input medical images. The pixel values are not a blend of information (for example, averaged values, maximal value, or other methods) from two or more of the medical images being stitched. Using values from only one input image for each side of the stitching surface may preserve important clinical information (for example, important for diagnostic purposes), preserve image resolution, prevent new artifacts from being formed (i.e., artifacts that did not exist in the original images), reduce artifacts in the EFOV and/or prevent or reduce faulty diagnosis. Gain correction may be performed on individual medical images, to align gain between images. Such gain correction does not blend data between pixels, and preserves original relative pixel values. Data on either side of the stitching surface may be obtained from gain corrected images.

Optionally, multiple stitching surfaces are identified. The stitching surfaces may be arbitrary and/or be of any dimension, according to the input image (for example, 2D, 3D, and 4D). The stitching surfaces may be continuous with one another. The stitching surfaces may be multi-planar, for example, including different planes, such as at different angles relative to one another, and/or parallel planes. The stitching surfaces may be non-continuous (i.e., discrete), with different stitching surfaces calculated to stitch different regions of the images. The computed surfaces are calculated such that the stitches do not cross nor intersect the artifacts. The multiple stitching surfaces may divide the EFOV into consecutive regions that may have clinical meaning, such as regions other than artifacts. The multiple stitching surfaces may improve the EFOV of the stitched image, by selecting the largest possible EFOV, which may be larger than for example, when stitching is based on a single surface and/or plane. The multi-plane stitching surfaces may provide additional degrees of freedom so that the stitching surfaces may be selected to stitch together similar regions, which may reduce (or make invisible) the stitched region, and/or prevent or reduce distortions of the true anatomy within the EFOV. The multiple stitching surfaces may join together images of different sizes and/or shapes, which form the largest possible EFOV image. Where several different sizes of EFOV images may be generated based on different calculated stitching surfaces (the stitching surfaces being defined under constraints described herein), the stitching surfaces are selected to generate the largest possible EFOV image from the received images. The largest EFOV image may alternatively or additionally be formed by first calculating an overlapping region between the images, and then the non-overlapping regions of each respective medical image are added to the overlapping region. The largest EFOV image may be formed from medical images of arbitrary size and/or geometry. Received images do not need to be formatted and/or provided with a predefined shape and/or geometry. Medical images that vary from one scan to another may be joined together. For example, US images acquired with different settings (for example, of the transducer) selected to acquire optimal images per patient and/or per view point may be joined together.

Optionally, the stitching surfaces are selected to account for differences between the images in the way in which the object of interest is perceived. The same object may be perceived differently in the respective medical images, for example, at a different angle and/or with different image acquisition parameters. The stitching surfaces may be selected based on similarities (i.e., a similarity metric and/or similarity map as described in greater detail below) between the respective medical images that are retained in spite of the differently perceived object.

Optionally, the stitching surface is selected to have one or more of the following characteristics: the stitch being undetectable to a human observer, the stitching surface produces an anatomically coherent image when stitched, and/or the resolution or each region among the input images is increased. The stitching surface may be selected by identifying locations that satisfy multiple conditions related to the image type, for example, based on the similarity metric and/or similarity map.

The methods and/or systems described herein may stitch together two dimensional (2D) images, three dimensional (3D) images, four dimensional (4D) images, or images with other classifications and/or arbitrary dimension medical images.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

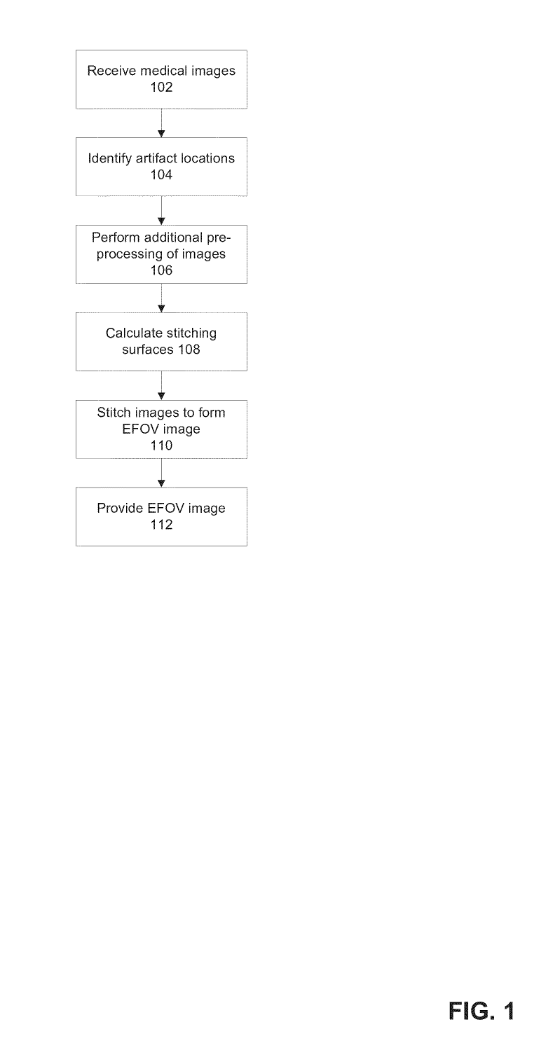

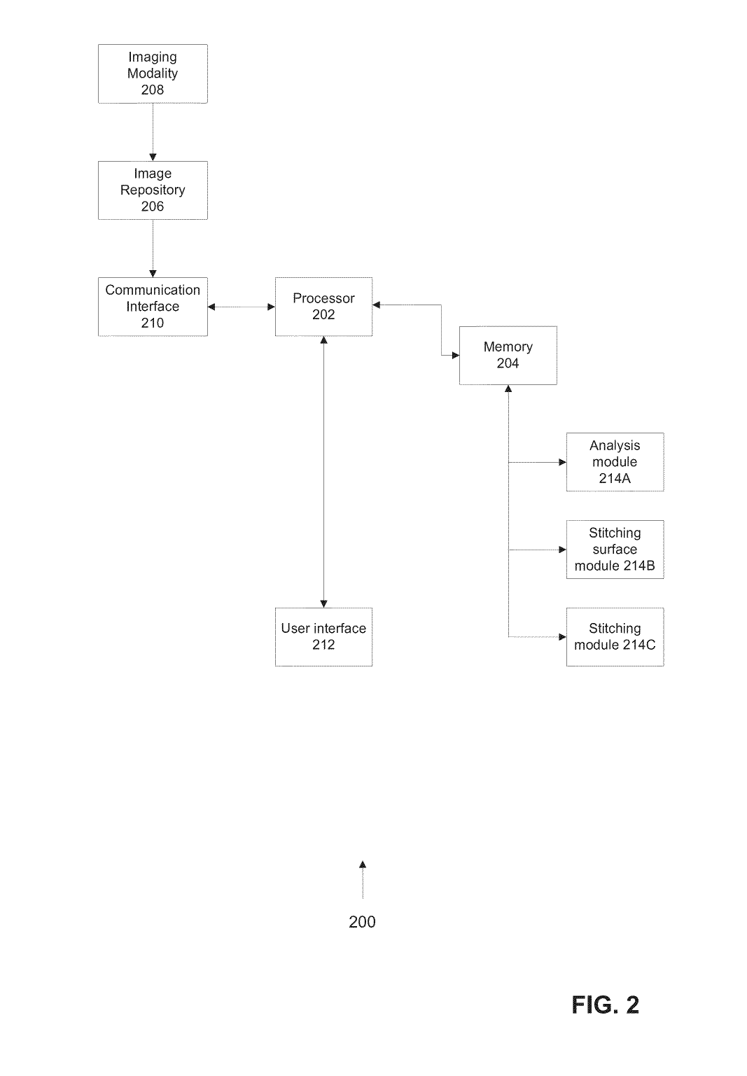

Reference is now made to FIG. 1, which is a flowchart of a computer-implemented method of stitching medical images to form an EFOV image having un-edited imaging artifacts from all stitched medical images, in accordance with some embodiments of the present invention. Reference is also made to FIG. 2, which is an exemplary system for stitching medical images to form an EFOV image having un-edited imaging artifacts from all stitched medical images, in accordance with some embodiments of the present invention. The method of FIG. 1 may be executed by the system of FIG. 2. The method and/or system calculate multiple stitching surfaces without crossing and/or intersecting boundaries of imaging artifacts identified within each medical image. Values on either side of the stitching surface may be obtained from original medical image data (i.e., from respective images), without compounding values between images. In this manner, the generated EFOV image may have higher resolution and/or may better preserve imaging information. The generated EFOV may be seamless, having a stitching seam that is not visible to a human observer, or only visible upon close examination. The seam may be selected based on medical imaging artifacts within the received images, so that the seam is undetectable and/or non-disruptive to the user.

The system and/or method may generate high resolution EFOV images. The EFOV may contain fewer artifacts, may preserve existing artifacts, and/or may prevent or reduce formation of new artifacts (i.e., from the stitching process), for example, as compared to stitching based methods that do not consider the artifacts.

System 200 includes one or more processors 202 in electrical communication with one or more memories 204 having stored thereon one or more modules having instructions for execution by processor 202, for example, modules 214A-C as described herein. System 200 may be installed as software, (for example, installed on an existing radiology workstation), as a plug-in box (for example, connected to a network such as a hospital local area network), and/or as a remote server (for example, providing services through a webpage and/or internet connection). One or more optional user interfaces 212 are designed to allow the user to enter data (for example, select images to combine) and/or to display the generated EFOV image. User interface 212 may include, for example, one or more of: monitor, projector, keyboard, mouse, keyboard, and voice recognition software.

The system and/or method may generate a high resolution EFOV image, which is anatomically correct. A single coherent image of the entire organ of interest may be generated (for example, heart, liver, fetus, spleen). The stitched regions may be undetectable to a human observer.

The system and/or method described herein may be used, for example, to create the EFOV volume for 3D medical images from cardiac US scanners. The entire human heart may be visualized in a single, coherence volume of the EFOV, rather than in multiple images. In another example, images acquired from a positron emission tomography (PET)/CT system may form EOV images of the whole body. Such whole body images may serve as a basis for diagnosis of, for example, multiple and/or diffuse vertebra and/or spinal cord disease. In yet another example, image data acquired from multi-channel imaging modalities such as multispectral CT or microscopy may be stitched to create EFOV images that are continuous and/or seamless with respect to all data channels.

Optionally, at 102, medical images and/or data denoting medical images are received, for example, from a medical imaging repository 206 storing multiple acquired medical images. The repository 206 may be in electrical communication with an imaging modality 208 (for example, US, CT, and MRI). The imaging modality may be a multi-spectral modality (for example, multi-spectral CT, multi-spectral microscopy). Processor 202 may connect to repository 206 using a communication interface 210, which may be permanent or temporary, wired or wireless, for example, a network connection, a cable, a portable media port (for example, CD-ROM drive, and SD card port).

The received medical images contain multiple imaging artifacts. The artifacts may be unique to the type of imaging modality. For example, CT images and US images may have different artifacts, such as due to the nature of the respective imaging modality.

Two or more medical images of the same imaging modality are received, for example, all received images are US images. Optionally, the received medical images are all acquired by the same imaging machine. Alternatively, the received medical images are not necessarily acquired by the same imaging machine, and/or during the same acquisition session.

The medical images may be of arbitrary dimension, for example, 2D, 3D, 4D, or greater (for example, for multi-spectral images).

The received medical images are registered. The images may be received pre-registered, or registration may be performed by suitable methods, for example, as described with reference to U.S. Patent Application Publication No. US 2013/0021341 to Choi et al., incorporated herein by reference in its entirety.

Optionally, at 104, the received medical images are analyzed to identify artifacts, for example, by an analysis module 214A for analyzing the medical images to identify the locations of the artifacts. The artifacts may be identified per pixel, per group of pixels, per image feature, or based on other methods. The location of each artifact may be identified.

Analysis methods to identify the location of artifacts may differ between imaging modalities and/or between artifact types. Different and/or multiple methods may be used to identify the different types of artifacts.

For example, in US images, exemplary artifacts that are detected include: speckles, shadows and artifacts caused by multi line acquisition analysis such MLA seams.

The speckle location may be determined by analysis of the image intensity, for example, as described by Wagner R F et al. “Statistics of Speckle in Ultrasound B-Scans”, IEEE Transactions on Sonics and Ultrasonics, Vol. 30, No. 3, 1983, incorporated herein by reference in its entirety.

The backscatter generated by diffuse scatterers may adhere to a Rayleigh distribution. The Rayleigh distribution for pixel intensities I may be defined based on a single parameter as defined in Equation 1:

$$p ( I \vert σ ) = \frac{I}{{σ}^{2 }} exp ( - \frac{{I}^{2}}{2 {σ}^{2}} ) \qquad Equation 1$$

The probability that a diffuse scatterer produces a given measurement may be determined when the scattering parameter σ is known. The parameter σ may be estimated by analyzing a histogram from regions of weak backscatters in the image. Based upon the assumption that in such an area the histogram resembles the speckle distribution, the location of the histogram maximum may serve as an estimate of the parameter σ. The probability of observing a given intensity measurement I or larger from a weak scattering region given the Rayleigh parameter σ may be calculated by integrating Equation 1.

Equation 2 provides a method for quantifying whether measurements are due to speckle or not.

$$p ( I \geq i \vert σ ) = exp ( - \frac{{i}^{2}}{2 {σ}^{2}} ) \qquad Equation 2$$

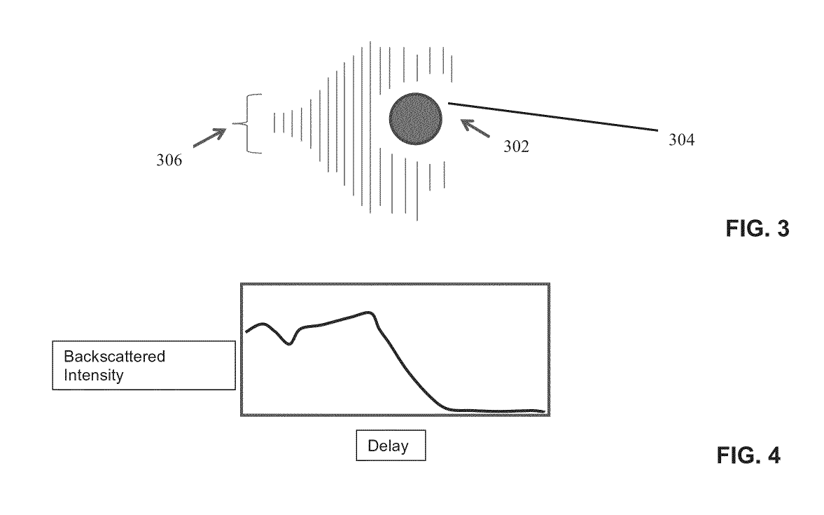

Shadow artifacts may be identified. Differences in (standardized) intensity levels between images may suggest that shadowing may be responsible for the observed differences. The shadow(s) may be identified from a single image of a single view by finding sharp losses in intensity in regions behind strong scattering objects. The phenomenon is illustrated with reference to FIG. 3, which is a schematic diagram depicting an exemplary case of a shadow region 302 by a sphere 304, when an US transducer 306 generates US energy towards sphere 304, to help understand embodiments of the present invention. The difference between expected resolution, provided or calculated from transducer and/or system characteristics, and calculated resolution (for example, Equation 5 below) may also be used. Additionally, multiple images representing different views may be exploited to detect the shadow, based on the shadow being characterized by differences in resolution or intensities between views. The phenomenon is illustrated with reference to FIG. 4, which is a graph depicting intensity measurements obtained from backscattered US, to help understand some embodiments of the present invention. As is apparent from the graph, little intensity is measured behind the scatterer.

Artifacts due to multi line acquisition may be identified. The method of MLA for increasing the frame rate and line density consists of emitting a wide beam, and receiving more narrow beams simultaneously. The interference between the simultaneous receiver beams creates line pattern artifacts and reduces image quality. The presence and locations of MLA seams may be calculated a priori from predefined details of the transducer and/or ultrasound monitoring system. The MLA seams are expected to be characterized by loss of resolution due to the data fusion in creating the line. More generally, differences in resolution may be the result of MLA. Other suitable methods may be used, for example, the artifact locations may be manually identified by the radiologist, and/or automatically provided by the imaging modality device. For example, a table denoting the artifact locations is provided from an external source.

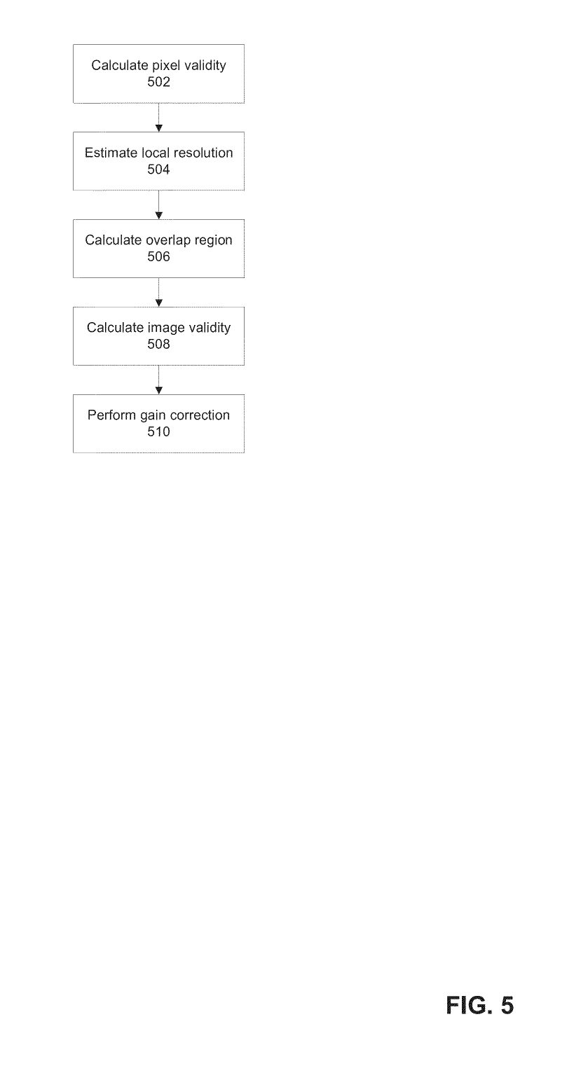

Optionally, at 106, additional pre-processing is performed based on the received medical images. Reference is now made to FIG. 5, which is a flowchart of a computer-implemented method for performing additional pre-processing based on the received medical images, in accordance with some embodiments of the present invention.

Optionally, at 502, a validity value is calculated. The validity value may be calculated based on the identified artifact locations (of block 104). The validity value may be calculated per pixel, per group of pixels, per image feature, or based on other methods.

Optionally, the validity value is a probability value based on the probability that each identified artifact (optionally at each respective pixel) is actually an artifact. For example, a value between 0 and 1 is assigned. Alternatively, the validity value is a binary value, denoting the presence or absence of artifact, optionally at each respective pixel. Other suitable validity value methods may be used.

As described herein, the plurality of stitching surfaces may be calculated based on the validity values, so that pixels more likely to be artifacts are avoided by the stitching surfaces.

In one example, each pixel of each medical image is assigned a calculated validity value based on the identified artifact locations (block 104), as denoted by Equation 3:

$${v}_{ik} = {\sum }_{j} {∝}_{j} {f}_{j} ( {I}_{k} ( i ) ) \qquad Equation 3$$

where:

Iₖ denotes a given input image;

i denotes a specific pixel in the image;

j denotes the artifact index. In the case of US, j=[1 . . . 3] is an index selected from the group consisting of [speckles, shadow, MLA];

∝ⱼ denotes a weight associated with the artifact j; and

fⱼ denotes a sanity function for artifact j (for example, decreasing with artifact penalty).

Optionally, at 504, location resolution is estimated. Local resolution may be quantified from spatial measures, such as from spatial correlation.

In one exemplary method, local correlation in the intensity image denoted by I/(\vec{τ}) may be summarized by the auto-correlation function, given by Equation 4:

R(\vec{τ})= [symbol] I(\vec{τ}),I(\vec{τ}+\vec{θ}) [symbol] Equation 4

Where \vec{θ} denotes the neighborhood of the pixel, supporting the autocorrelation estimation.

The rate of change of the autocorrelation is calculated, particularly as determined from its curvature and transformations related to curvature, for example, the divergence of the autocorrelation and the eigenvalues of the Hessian matrix. The elements of the Hessian, normalized by the maximum of the autocorrelation, are given by Equation 5:

$${H}_{{m}_{1} , {m}_{2}} = \frac{{\frac{{\partial }^{2} R ( \vec{τ} )}{\partial {τ}_{m 1} \partial {τ}_{m 2}} \vert}_{\vec{ς} = \vec{0}}}{R ( \vec{0} )} , {m}_{1} , {m}_{2} ∈ \{ 1 , 2 , … , n \} \qquad Equation 5$$

where n is the dimension of the input US images.

Equation 5 describes the curvature of the autocorrelation result. The larger the eigenvalues of H, or its divergence, the more spatial variability, or bandwidth, is present in the backscattered image. In addition to intensity, differences in curvature provide complementary measures of information. By analogy with the intensity based speckle detector function described above, the measure of curvature may be statistically tested for equality between two image scenes to determine their similarity.

Alternatively or additionally, details of local resolution may be obtained based on a priori information of transducer focal zone position, or by other suitable methods.

The calculated resolution parameter may be used for calculation of the stitching surfaces as described below.

Optionally, at 506, one or more overlapping regions between two or more of the received medical images are calculated. Suitable methods may be employed to calculate the overlapping regions, for example, by means of detecting foreground pixels placed at the same location of the joint physical coordinate system (i.e. the coordinate system used by all registered inputs).

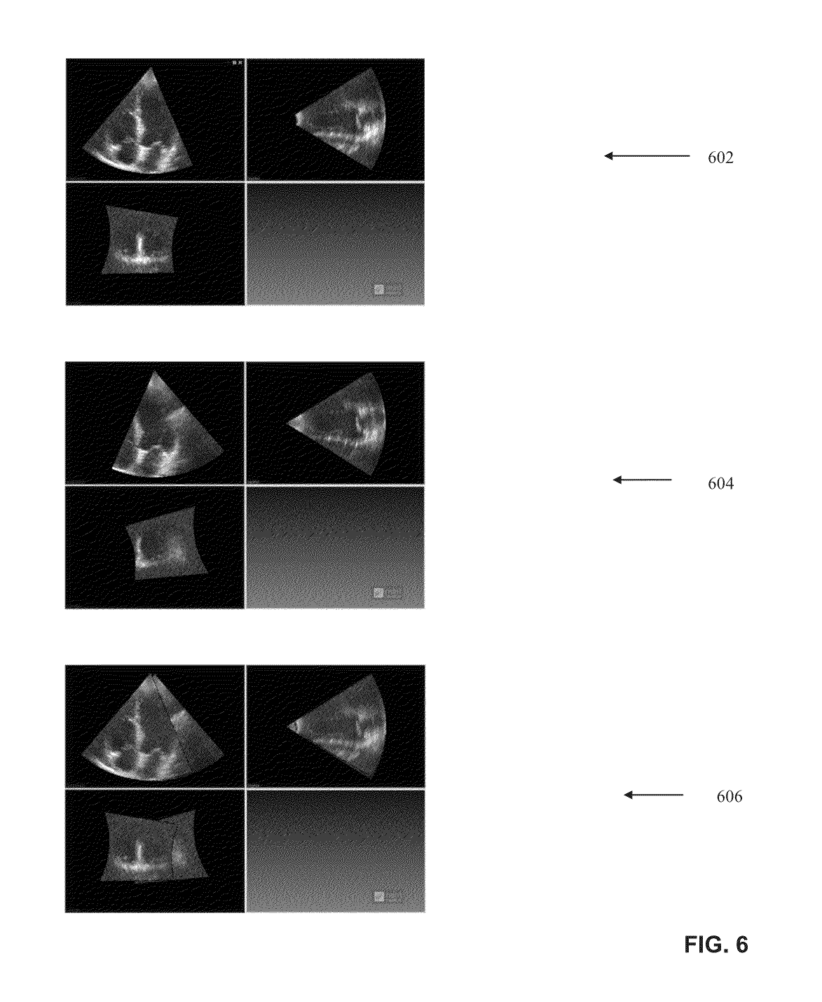

Reference is made to FIG. 6, which depicts a first exemplary received US medical image 602, a second exemplary received US image 604, and aligned first and second images with superimposed overlapping regions 606 (shown in red), in accordance with some embodiments of the present invention.

Referring back to FIG. 5, optionally, at 508, a global validity value for each received medical image is calculated. The global validity value may be calculated based on the calculated validity value per pixel, or other groupings (for example, as described with reference to block 502), optionally located within the calculated overlapping region.

In one exemplary method, each image k is associated with a global validity value V(k) based on Equation 6:

$$V ( k ) = {\sum }_{i ∈ overlap region} {v}_{ik} \qquad Equation 6$$

Optionally, a dominant medical image is selected from the set of received medical images. Optionally, the dominant medical image is selected based on relative calculated global validity values of respective medical images. For example, the input I_{ref} having the maximal validity weight within the overlapping region is selected to be of greater importance based on Equation 7:

k_{ref}=argmaxₖV(k)

I_{ref}=Iₖ_{_{ref}} Equation 7

Optionally, at 510, an appropriate gain correction is calculated and applied to other non-dominant medical images with lower validity. The gain correction is applied to match the other non-dominant images to the dominant image, so that the respective medical images have similar global intensities.

Alternatively, the received medical images already have similar gain levels. In such a case, no additional gain control is performed.

The gain may be calculated by identifying valid sub-regions within the overlapping region based on the calculated validity value (optionally per pixel), for example, relative to a threshold value. The selected sub-regions are determined to be valid in each respective medical image contributing to the overlapping region. Pixel intensities of each identified valid sub-region may be manipulated (to perform the gain correction) based on a global matching of the identified sub-regions. Other sub-regions may be adjusted in proportion to the calculated validity value based on the global matching, in a different manner, for example, less valid regions are adjusted less.

Optionally, in one exemplary method, gain correction is applied to match the image with smaller validity to I_{ref}. Optionally, the gain correction is based on histogram matching of selected regions. Only overlapping regions considered valid in both (or more) received images are taken into account for the computation of the gain correction process. A suitable validity measure may be defined based on blocks 502 and/or 508 of FIG. 5. The set of valid pixels for this purpose may be based on Equation 8:

Ωₖ={i,ν_{i,k}>T} Equation 8

where:

i denotes the pixel index in the overlapping region of the received images;

k denotes the input index;

ν_{i,k} as defined by Equation 3; and

T is a selected validity value threshold.

The gain correction may be applied to the entire image (or parts thereof) in an adaptive manner. Optionally, regions selected as valid have their intensities manipulated, for example, according to a global mapping of the histogram matching process. Optionally, other regions are adjusted in proportion to their validity measure, for example, the less valid a region the less effect the global mapping has.

The mapping may be denoted by Equation 9:

I′ₖ(i)=g(ν_{i,k},Iₖ(i)) Equation 9

where:

i denotes the pixel index of the images;

k denotes the input index;

ν_{i,k} as defined in Equation 3;

Iₖ denotes the input image;

g denotes the mapping function; and

I′ₖ denotes the intensity adjusted image.

Alternatively, the gain correction is simplified by ignoring the validity measure. Optionally, histogram matching is performed on the entire overlapping region, and the mapping is applied onto the entire image.

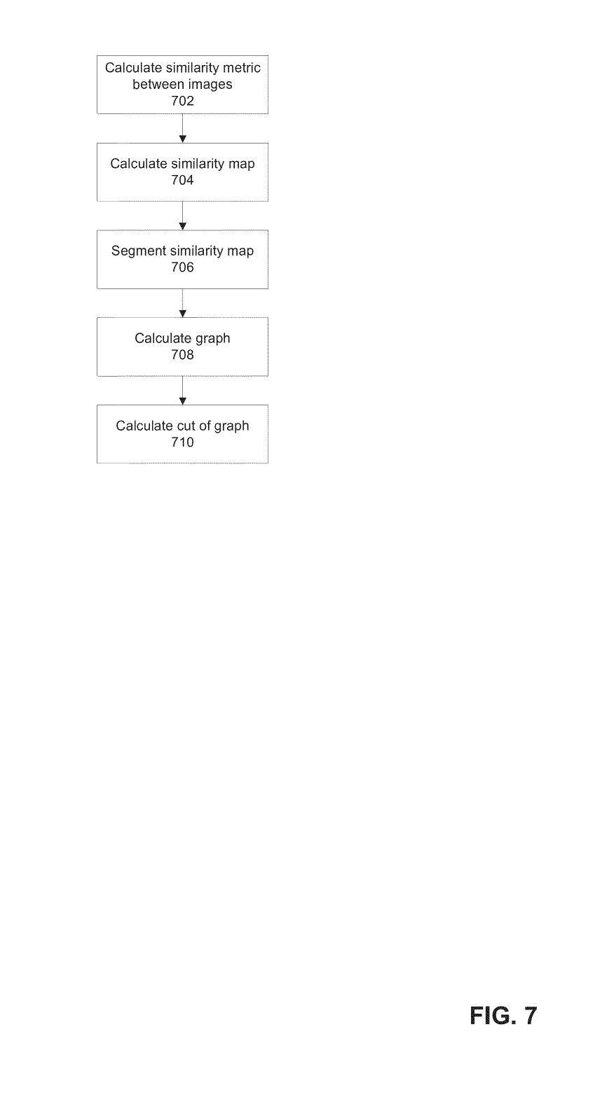

Referring now back to FIG. 1, at 108 one or more stitching surfaces are calculated for each respective received medical images pair, for example, by a stitching surface module 214B for calculating stitching surfaces, so that the surfaces do not intersect and/or cross over each (or some or most) of the boundaries of the imaging artifacts. The stitching surfaces may have different planes. The stitching surfaces are calculated such that seams connecting between the stitching surfaces are outside of the boundaries of the imaging artifacts. Reference is now made to FIG. 7, which is an exemplary computer-implemented method for calculating stitching surface(s) for received medical images, in accordance with some embodiments of the present invention.

The method selects the data for display in the EFOV image from respective received medical images without applying additional intensity processing. Such an approach may prevent or reduce data loss that may have significant clinical importance and/or may prevent or reduce the probability of introducing artifacts. Stitch surfaces separating the medical images are calculated based on each side of the surface data being derived from only a single image, without compounding of data between images.

Even after optional gain correction (block 510 of FIG. 5), the images may appear different, due to the various artifacts associated with the imaging modality. The stitching surface is selected based on the artifacts, to optionally form a seamless EFOV and/or preserve structures at high resolution.

Optionally, the method selects the stitching surface based on one or more of the following constraints:
Image regions in the neighborhood of the stitching surface have high similarity to each other, which may reduce visibility of the seam after stitching.
Anatomical structures are not disrupted by the stitching surface and/or after stitching.
Regions defined as important are not split by the stitching surface. The importance of a region may be defined, for example, by various parameters inferred from the pre-processing stages (for example, blocks 104 and/or 106 of FIG. 1), for example defined by a similarity map described herein.
Image regions in the neighborhood of the stitch have similarly low resolution, which may reduce seam visibility.

Optionally, the stitching surfaces are selected so that pixels of the overlapping region of the medical images have high similarity between pixels of respective medical images. Alternatively or additionally, the stitching surfaces are selected so that neighborhoods of the stitching surfaces have high similarly and low resolution at each respective medical image.

Optionally, one or more stitching surfaces are calculated, the surfaces including multiple different planes so that the surfaces are positioned a distance away from each of the identified imaging artifacts (i.e., outside the boundaries of the artifacts), such that the surfaces do not cross over and/or intersect the imaging artifacts. Multiple planes are calculated instead of a single line or a single plane. In this manner, the artifacts are not crossed by the stitching surfaces.

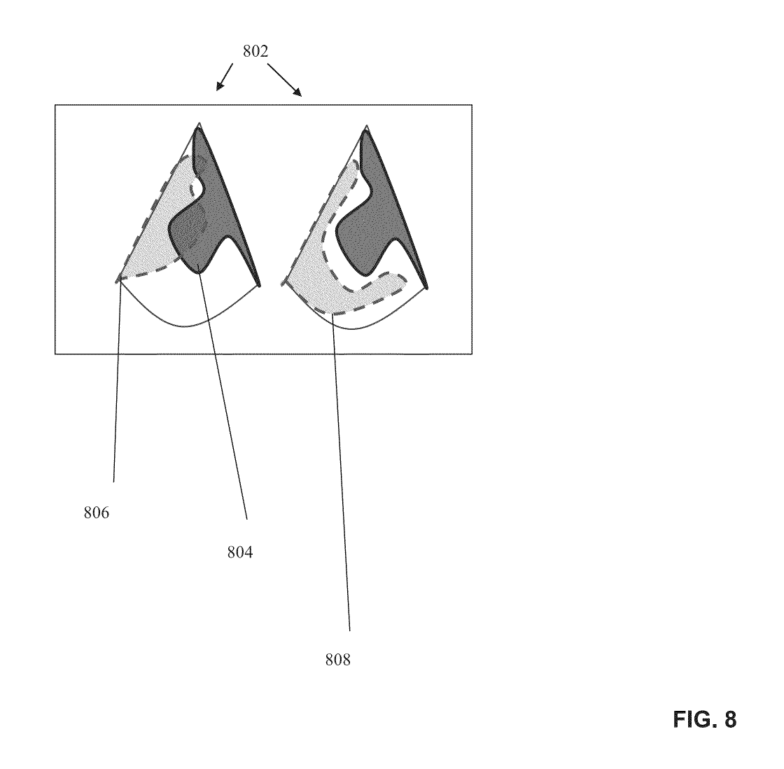

Reference is made to FIG. 8, which is a schematic diagram of a 2D slice of an

US image 802 having an important region 804, showing an erroneously selected stitching surface 806 and a correctly selected stitching surface 808, in accordance with some embodiments of the present invention. The erroneously selected stitching surface 806 splits important region 804, while correctly selected stitching surface 808 is constraint to not cross into important region 804.

Referring now back to FIG. 7, optionally, at 702, the similarity between two or more received medical images is determined Optionally, a similarity metric is calculated.

Optionally, the similarity between the two images is calculated in the overlap region by using a defined metric, which optionally includes generating a similarity image (denoted by S below). The stitch surface may be selected to pass along the most similar pixels.

An exemplary method for selecting the stitching surface may include an intensity parameter. The intensity parameter may be measured based on, for example, complement of Sum of Absolute Differences (SAD), Normalized Cross Correlation (NCC), Mutual Information (MI), or other suitable methods. The higher the value of the parameter, the higher the similarity may be.

Alternatively or additionally, the method for selecting the stitching surface may include a parameter based on the artifact, for example, based on the pixel validity (for example, block 502 of FIG. 5), such as the probability of the pixel being an artifact. Splitting the artifact is selectively avoided or reduced, as splitting such an artifact may produce a new, unknown artifact. As the artifact probability increases, the similarity may decrease.

Alternatively or additionally, the method for selecting the stitching surface may include a parameter based on resolution. The resolution based parameter may be obtained, for example, from the imaging machine, such as from the focal zone defined in the acquiring US machine. In another example, the resolution may be calculated as described in block 504 of FIG. 5. A combination of the two methods may yield even more accurate results as the comparison between expected resolution and actual resolution may reveal additional artifacts. The stitch surface may be selected along low resolution regions. When the resolution is low in both inputs the similarity value may increase.

Optionally, at 704, a similarity map is calculated based on the similarity metric, such as the similarity value and/or metric described in block 702. Optionally, the similarity map denotes the overlapping region. Optionally, the similarity map denotes pixel similarity between respective medical images.

Optionally, the similarity map is normalized. Alternatively or additionally, the similarity map is converted into binary form, for example, similarity values above a threshold are converted into one value (for example, 1) and values below the threshold are converted into another value (for example, 0). Alternatively or additionally, the similarity map denotes a continuum of similarity values, for example, between 0 and 1.

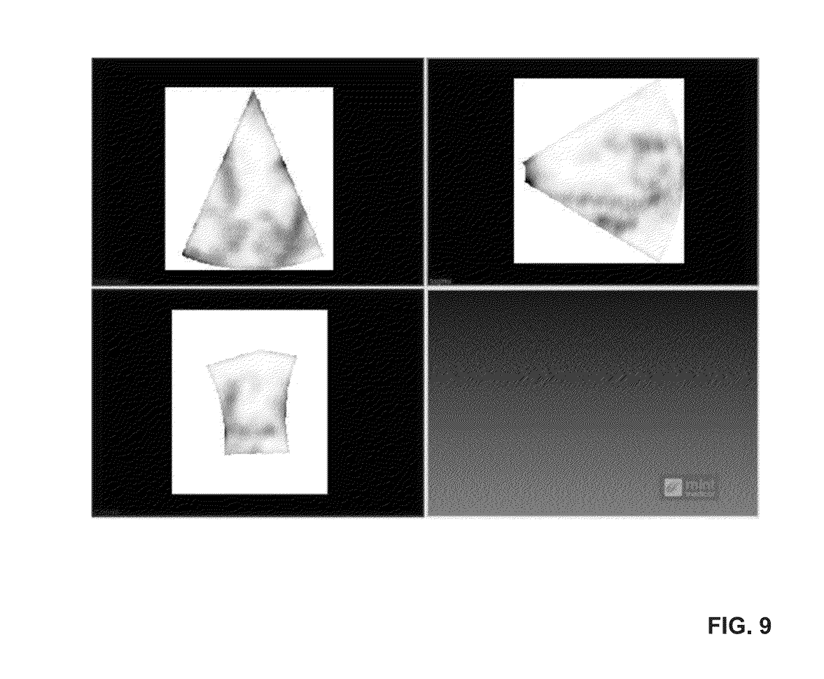

Reference is now made to FIG. 9, which is an exemplary similarity map, in accordance with some embodiments of the present invention. FIG. 9 illustrates a normalized similarity map in the overlap region, based on only an intensity based similarity metric (for example, as described with reference to block 702 of FIG. 7). The white pixels correspond to higher similarity values. Black pixels correspond to lower similarity values.

Referring now back to FIG. 7, optionally at 706, the similarity map is segmented. Optionally, the similarity map is segmented to unify regions which are the least similar and/or identify borderlines where the medical images are the most similar. Suitable segmentation methods may be used, for example, a watershed algorithm, a region growing algorithm with multiple seeds, and/or another suitable algorithm. Segmentation may reduce run-time complexity in subsequent processing stages.

The level of detail of the stitching surface may be controlled. At one extreme where each pixel is a segment, the stitch surface algorithm has the most flexibility in determining the stitching surface. As the segments become bigger this flexibility is selectively reduced.

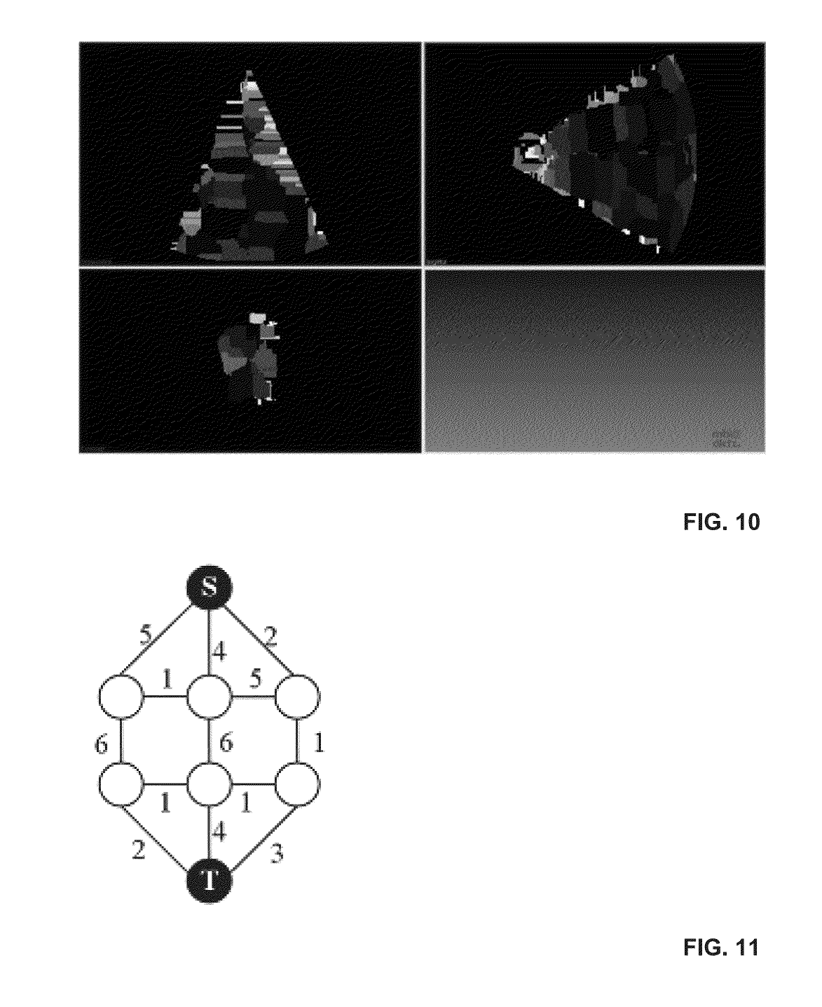

Reference is made to FIG. 10, which is an exemplary image of a segmentation map based on the inverse of the similarity map of FIG. 9, in accordance with some embodiments of the present invention. The segmentation map is calculated based on the watershed algorithm.

Referring now back to FIG. 7, optionally at 708, the stitching surface is identified based on the segmentation map. Optionally, a graph is calculated based on the segmentation map. The graph may be a source-sink (denoted s-t) graph.

Optionally, a weight value between two vertices incorporating the artifact probability is selected to prevent crossing of the artifact zone by the stitching surfaces.

An exemplary method of building the s-t graph includes representing each segment of the segmentation map by a vertex and assigning weights. Between two vertices, the weight may be computed so that a penalty value is assigned to regions that should not be crossed. Exemplary weight formulation may be defined by Equation 10:

$${w}_{i , j} = {\sum }_{m ∈ boundary ( i , j )} W ( S ( m ) , {\{ {v}_{m , l} \}}_{l ∈ inputs} , U ( m ) , {\{ {I}_{i} ( m ) \}}_{l ∈ inputs} ) \qquad Equation 10$$

where:

i and j denote the vertices (segments) indices;

S denotes the similarity image (as described herein);

v as defined by Equation 3;

U denotes a function of the resolution similarity and quality (as defined herein);

{Iₗ}_{lεinputs} denotes the input images; and

m denotes the set of pixels along the border between the segments of interest.

Alternatively or additionally, another exemplary weight formulation is defined by Equation 11, where the complementary value of the validity measure is used to set higher weights within an artifact zone to avoid crossing of the artifact:

$${w}_{i , j} = {\sum }_{m ∈ boundary ( i , j )} S ( m ) + \overline{{min}_{k} ( {v}_{m , k} )} + U ( m ) + mean ( {\{ {I}_{l} ( m ) \}}_{l ∈ inputs} ) \qquad Equation 11$$

Additional constraints may be defined and/or incorporated into equations 10 and/or 11 to address a different set of artifacts, such as CT artifacts, MRI artifacts, or other US artifacts.

Optionally, the source and target vertices are added to the graph. The source and target are auxiliary vertices, and therefore are the only vertices that do not represent any concrete segment. The source is connected to a subset of vertices representing a consecutive portion of the outer boundary, while the target is connected to the remaining vertices of the boundary.

The choice of which subset to connect may be selected, for example, based on the desired result. In one example, the source is connected to all vertices representing the left side of the boundary and the target to those remaining Weights on all edges connected to the source and/or target may be set to infinity to ensure the result (i.e. the seam) is inside the overlap region.

Reference is now made to FIG. 11, which is an s-t graph generated based on a segmentation map, in accordance with some embodiments of the present invention. The s-t graph is made up of vertices and edges that connect the vertices. The edges have assigned weights. S corresponds to the source and T corresponds to the target.

The graph and other methods which may be suitable for calculating s-t graphs are described by Patrik Nyman, “Image Stitching using Watersheds and Graph Cuts”, Centre for Mathematical Sciences, Lund University, Sweden, 2009, incorporated herein by reference in its entirety.

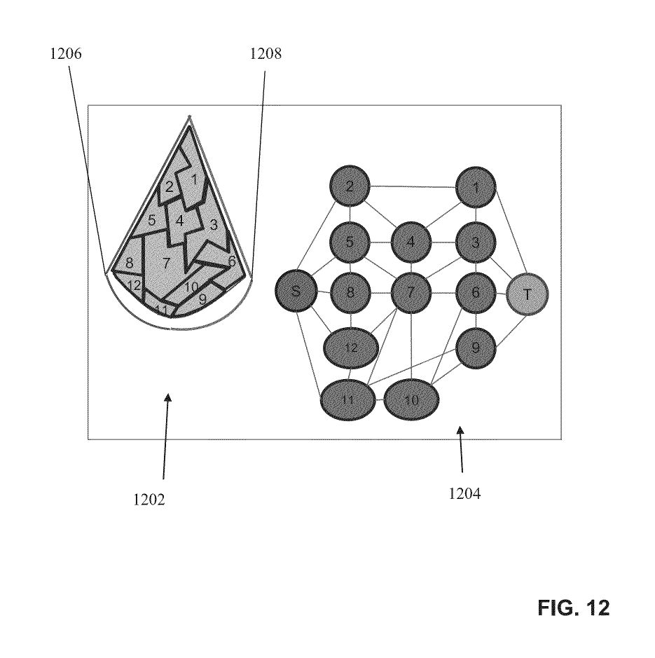

Reference is also made to FIG. 12, which is a schematic of an overlapping region with enumerated segments (i.e., segmented map) 1202, and a corresponding graph 1204 based on segmented map 1202, in accordance with some embodiments of the present invention. Segmented map 1202 contains a left outer boundary 1206 defining segments connected to a source, and a right outer boundary 1208 defining segments connected to a target. Graph 1204 has auxiliary source S and target T vertices. Edges are set between neighboring segments. It is noted that when a segment, such as segment 1, is in contact with both source area 1206 and target area 1208, the segment is connected to only one of the two vertices in the corresponding graph 1204.

Referring now back to FIG. 7, optionally at 710, a graph cut is calculated. The stitching surfaces are calculated based on the selected graph cut. The graph cut may be a minimum cut to a source-sink flow graph calculated from the segmented similarity map, as described herein. The minimum cut may denote the lowest total sum of the weight values.

The cut separating the source from the target may be calculated based on lowest cost, i.e. the cut with lowest total sum of the weights is calculated. In the resulting cut, every segment may be linked either to the source or the target. The obtained minimum cut may correspond to the optimal cutting surfaces, which may form a seam.

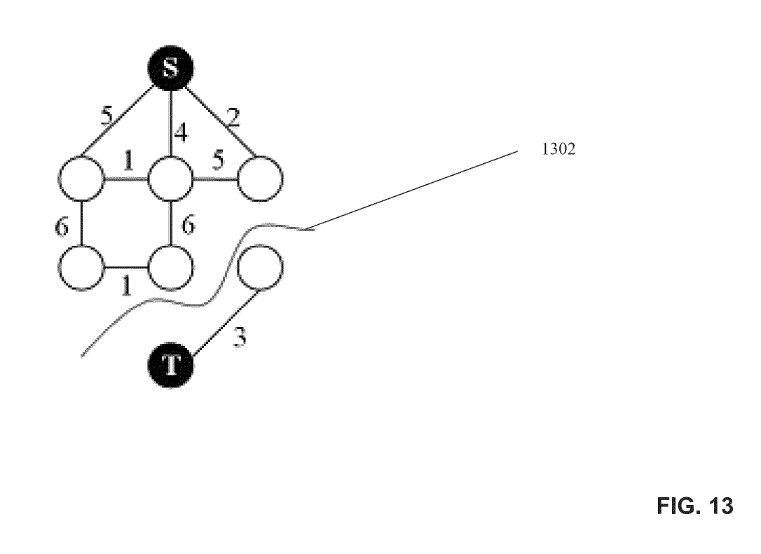

Reference is made to FIG. 13, which is an exemplary s-t graph with corresponding calculated minimum cut 1302, in accordance with some embodiments of the present invention. Cut 1302 is made to the graph of FIG. 11. Cut 1302 is calculated based on separation of source S and target T. The total sum of weights of the cut edges is calculated to have a minimal value. The stitching surfaces are identified based on cut 1302 and corresponding segmented regions. The cut and other methods which may be suitable for calculating graph cuts are described by Patrik Nyman, “Image Stitching using Watersheds and Graph Cuts”, Centre for Mathematical Sciences, Lund University, Sweden, 2009, incorporated herein by reference in its entirety.

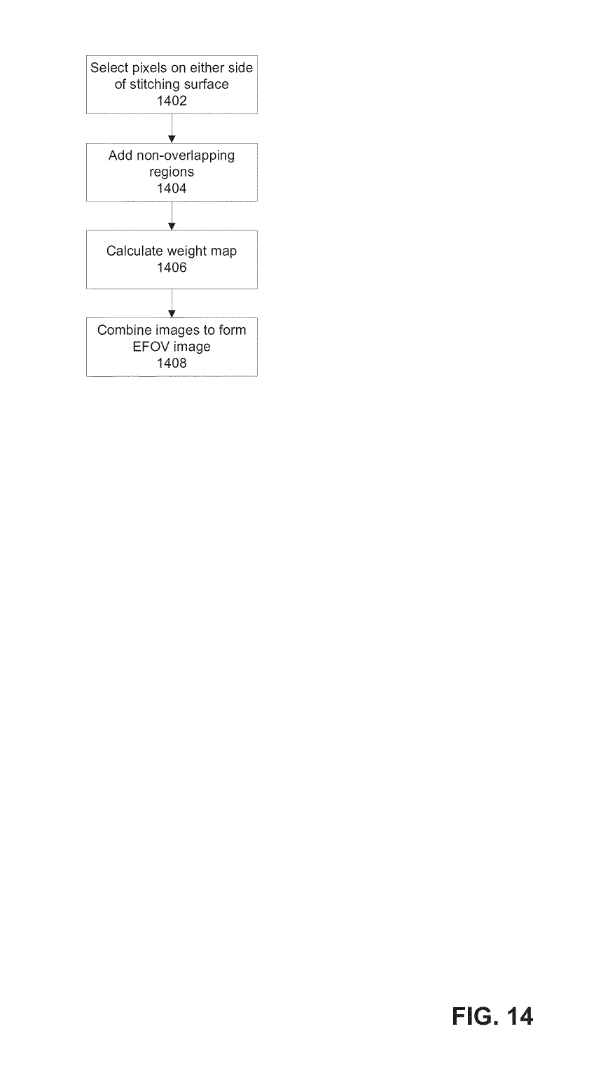

Reference is now made back to FIG. 1. At 110, the received images are stitched together based on the calculated stitching surfaces to form the EFOV image having un-edited imaging artifacts from all stitched medical images, for example, by a stitching module 214C for stitching the medical images based on the identified stitching surface, optionally with retained original pixel values from the respective medical image on each respective side of the stitching surface. Reference is made to FIG. 14, which is a flowchart of an exemplary computer-implemented method of stitching the received images, in accordance with some embodiments of the present invention.

Optionally, at 1402, pixels (or pixel groups, or image features) within the overlapping region for stitching on each side of the stitching surfaces are selected. Optionally, the pixels are selected based on the highest calculated validity pixel value of each respective medical image.

An exemplary method of selecting the pixels for either side of the stitching surface includes: Analyzing the validity of each pixel in the overlapping region twice, once with each validity map, associated to each of the input images (see equation 3). The analysis may be based on previous calculations at the preprocessing stage described with reference to equation 3. All pixels that are both under the given mask and within the overlapping region are used to define a score, given by Equation 12:

$$Z ( k ) = {\sum }_{i ∈ P} {v}_{ik} \qquad Equation 12$$

On each side of the stitching surface, the highest score input is then selected, for example, as denoted by Equation 13:

k_{bestFit}=argmaxₖZ(k) Equation 13

The exemplary method may result in either both inputs represented within the overlapping region or a single input selected for both sides. The two options are acceptable when they create a seamless stitch.

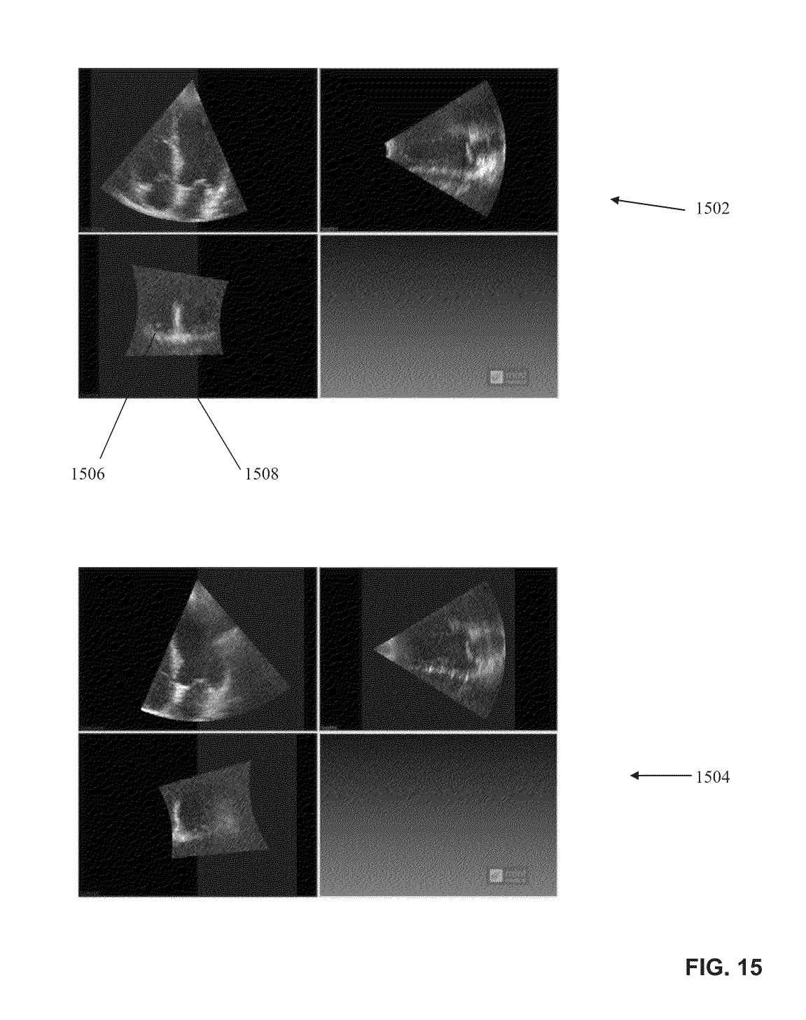

Reference is now made to FIG. 15, which denotes images with selected pixels on each side of the stitching surface, in accordance with some embodiments of the present invention. Image 1502 is the first medical image, and image 1504 is the second medical image, both shown superimposed with calculated position masks 1506. Pixels on either side of a stitching surface 1508 are selected from image 1502 or from image 1504, for stitching to generate the EFOV image.

Referring back to FIG. 14, optionally, at 1404, non-overlapping regions of each respective medical image are added to the overlapping region. The non-overlapping regions may include regions not considered in block 1402. Adding the non-overlapping regions may increase the size of the EFOV image.

Optionally, a stitching surface is calculated in a similar manner to that described with respect to block 108 of FIG. 1. The stitching surface may form a seamless stitch. The graph created with reference to block 708 of FIG. 7 is altered so that the source vertex is connected to all boundary vertices except those touching the region to be added and the target vertex is connected to the complementary boundary vertices. A minimum cut (based on block 710 of FIG. 7) may be found which defines a stitching surface between the overlapping region and the new region. It is noted that this process helps assure that the largest possible EFOV image is created. Non-overlapping regions of each respective medical image may be added to the overlapping region such that the largest possible EFOV image is generated.

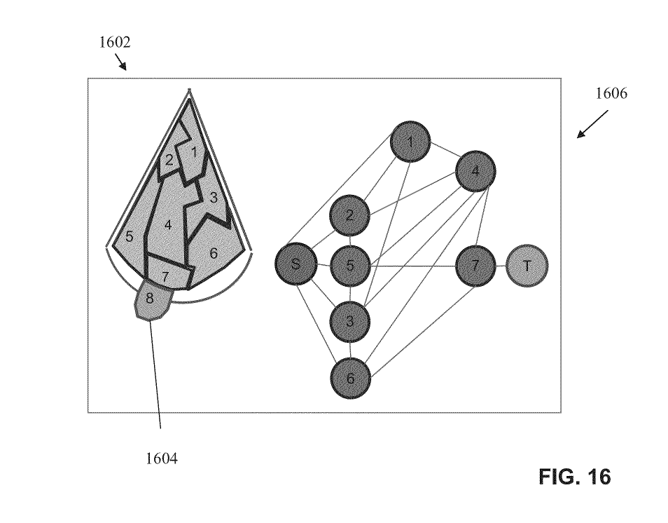

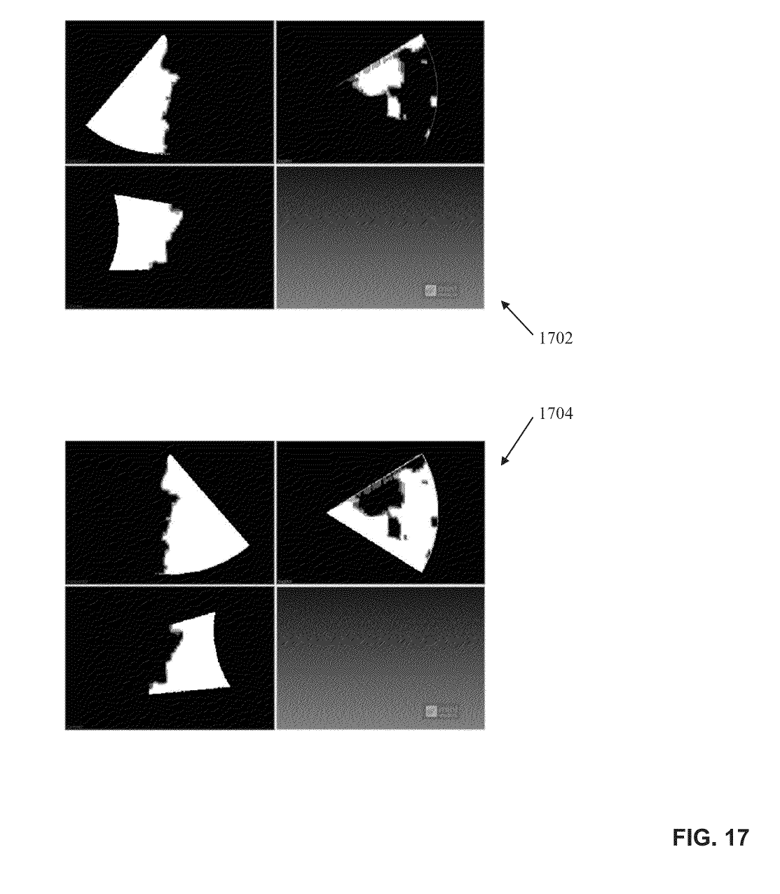

Reference is now made to FIG. 16, which is a schematic of an overlapping region 1602 with enumerated segments (i.e., segment map) including a non-overlapping region 1604 to be added, and a corresponding graph 1606, in accordance with some embodiments of the present invention. Segments 1, 2, 3, 4, 5, 6, 7 of overlapping region 1602 define segments connected to the source. Segment 8 is the non-overlapping region 1604 to be added. Corresponding graph 1606 includes auxiliary source S and target T vertices. Edges are set between neighboring segments. The target is connected only to segment 7 (the only neighbor of segment 8 which is added) to assure that the new stitch surface is added in the desired location. Segment 8 does not appear in the graph since it does not belong to the overlapping region.

Optionally, at 1406, a weight map is calculated for each respective medical image. The weight map may indicate for any pixel (or group of pixels or image feature) the respective weight of the pixel in the EFOV image. The map may be calculated based on the selected pixels on either side of the stitching surface.

Optionally, images are blended in a binary manner. Every pixel weight may be set to a minimal or maximal weight value, for example, 0 or 1. Each side of the stitch surface is assigned a uniform value. The setting may be based upon the calculated input position on either side of the stitching surface (for example, block 1402). Optionally, the images are blended in the stitching surface neighborhood, which may decrease seam visibility. The binary formatting may conserve image quality.

Optionally, the blending is based on linear intensity interpolation. Pixels with a high intensity difference between the images may not be blended, which may conserve details and/or edge sharpness. Alternatively or additionally, the blending is adaptive, for example, based on the local frequency in the pixel's neighborhood. Alternatively or additionally, blending is mixed, for example, low frequencies are linearly blended while high frequencies remain unchanged. Other blending methods may also be used.

Reference is made to FIG. 17, which are exemplary weight maps, in accordance with some embodiments of the present invention. Weight maps 1702 are based on a first medical image, and weight maps 1704 are based on a second medical image. The pixel color may denote the weight value, for example, as shown, white pixels denote maximal weight, black pixels denote minimal weight, and gray pixel denotes blending of the two images.

Referring now back to FIG. 14, optionally, at 1408, the medical images are combined to generate the EFOV image. The images may be combined based on the respective binary pixel maps and/or computed weight maps. The binary pixel maps may be blended in a neighborhood of the seam to decrease seam visibility. Optionally, pixels having a high intensity difference between respective medical images are not blended to conserve details and/or edge sharpness.

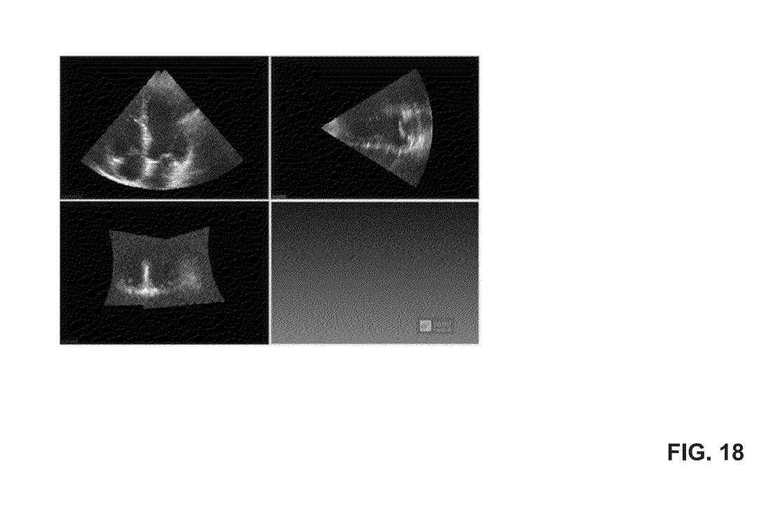

Reference is now made to FIG. 18, which is an EFOV image based on two separate medical images, combined based on methods described herein, in accordance with some embodiments of the present invention. The seam in the overlap region is invisible, and the field of view is extended to the maximum possible.

Referring now back to FIG. 1, optionally at 112, the EFOV image is provided. The EFOV has un-edited imaging artifacts from all stitched medical images. The EFOV image may be displayed for viewing (for example, on a monitor), may be stored (for example, on a memory), and/or may be forwarded (for example, to a remote server, such as for further analysis).

The EFOV may be generated to obtain high quality, (optionally 3D) US images that may include large anatomic structures. For example, of a full fetus view, for gynecologic applications, of abdominal organs, for mammography, of the thyroid, of duplex images (such as the carotid artery, or blood vessels in the arms and/or legs), and/or vascular applications.

The (intra-modality) EFOV may be provided for multimodality fusion applications utilizing (optionally 3D) US. For example, CT/MRI images have a large FOV. When US data is registered, the US EFOV may be created and provided to both modalities (CT and MRI) to cover the same anatomic region. In this manner, the doctor may perform a comprehensive analysis based on different clinical aspects.

The EFOV may be provided to quantify physiological data not available with a narrower field of view. For example, in echocardiography the 3D transducer is unable to acquire the entire heart from a single view. The EFOV may allow full imaging of the heart, which may allow extraction of important new parameters such as the heart volume, whole heart strain analysis (requiring a large view of the heart) and/or valve quantifications by the generated single EFOV image.

It is noted that the systems and/or methods described herein may provide EFOV images in multiple dimensions, including dynamic 4D US (3D volume+time), optionally by finding the stitching hyper-surfaces and/or seam in the higher dimension. The 4D image may have one or more of the following qualities:
The stitch may be invisible on static and/or dynamic images.
All regions may have original intensities.
Seam calculation may be highly adapted to US images.
The anatomic image may be complete and coherent.
Maximal resolution among input volumes.
Maximal volume of generated EFOV volume.
Applying the method in spatio-temporal space may allow for continuous and/or temporally consistent hyper-surface seams, which may avoid temporal artifacts that may occur in independent spatial seams calculations.

The systems and/or methods described herein may be extended to generate EFOV images for other volumetric imaging modalities, while maintaining one or more benefits (for example, as described in the previous paragraph and/or herein), for example, whole body PET/CT for the diagnosis of multiple and/or diffuse vertebra and/or spinal cord disease.

The systems and/or methods described herein may be applied to modalities with multi-channel image data (for example multispectral CT, multispectral microscopy). Optionally, by adapting the selected weight function calculation to the specific case. In this manner, EFOV images may be created that are continuous and seamless with respect to all data channels.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms medical image, imaging modality, imaging artifacts and EFOV image, are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method of calculating an extended field of view (EFOV) from medical images, comprising:
receiving a plurality of registered acquired medical images of a patient, the medical images having a plurality of imaging artifacts based on the medical imaging modality acquiring the medical images;
analyzing the plurality of medical images to identify locations of the plurality of imaging artifacts within the medical images;
calculating a plurality of multi-planar stitching surfaces such that seams connecting therebetween are outside the boundaries of the plurality of imaging artifacts; and
providing an extended field of view (EFOV) image having un-edited imaging artifacts from all stitched medical images.

2. The method of claim 1, further comprising stitching the medical images based on the identified stitching surfaces, each side of the stitching surfaces having retained original pixel values from one of the medical images.

3. The method of claim 1, wherein identify locations comprises calculating a validity value per pixel of the medical images based on the probability of each identified artifact being located at each respective pixel, and calculating the plurality of stitching surfaces based on the validity value, such that pixels more likely to be artifacts have reduced boundary crossing by the plurality of stitching surfaces.

4. The method of claim 3, further comprising:
calculating an overlapping region of the medical images;
calculating a global validity value for each medical image based on the calculated validity value per pixel located within the overlapping region;
selecting a dominant medical image based on relative calculated global validity values of respective medical images; and
applying gain correction to other non-dominant medical images with lower validity to match the dominant image, so that the medical images have similar global intensities.

5. The method of claim 4, wherein applying gain correction further comprises:
identifying valid sub-regions within the overlapping region based on the calculated validity value per pixel relative to a threshold value, the sub-regions being valid in each respective medical image of the overlapping region; and
manipulating pixel intensities of each identified valid sub-region based on a global matching of the identified sub-regions, and adjusting other sub-regions in proportion to the calculated validity value based on the global matching, so that less valid regions are adjusted less.

6. The method of claim 1, wherein calculating a plurality of stitching surfaces further comprises calculating the plurality of stitching surfaces at neighborhoods of the stitching surfaces having high similarly and low resolution at each respective medical image, to reduce visibility of a stitching seam based on the stitching surfaces.

7. The method of claim 1, wherein calculating a plurality of stitching surfaces further comprises calculating the plurality of stitching surfaces at pixels of an overlap region of the medical images having high similarity between pixels of respective medical images, to reduce visibility of a stitching seam based on the stitching surfaces.

8. The method of claim 7, further comprising calculating a similarity map of the overlap region denoting pixel similarity between respective medical images based on a similarity metric including at least one member of a group consisting of relative pixel intensity between the medical images, the probability of the pixel being the artifact wherein higher artifact probability denotes a lower similarity, and similarity of low resolution between the medical images.

9. The method of claim 8, further comprising segmenting the similarity map to unify regions which are the least similar and identify borderlines where the medical images are the most similar.

10. The method of claim 9, wherein calculating the plurality of stitching surfaces further comprises calculating the plurality of stitching surfaces based on a minimum cut to a source-sink flow graph calculated from the segmented similarity map, wherein a weight value between two vertices representing the artifact is selected to prevent crossing of the artifact zone by the stitching surfaces, the minimum cut denoting the lowest total sum of the weight values.

11. The method of claim 3, further comprising selecting pixels within an overlapping region for stitching on each side of the stitching surfaces based on analysis of the validity of each pixel in the overlapping region with each respective validity map of each respective medical image.

12. The method of claim 11, further comprising adding non-overlapping regions of each respective medical image to the overlapping region such that the largest possible EFOV image is generated from the received images.

13. The method of claim 2, further comprising calculating a binary pixel map for each respective medical image based on the selected pixels on either side of the stitching surface, and combining the medical images based on the respective binary pixel maps to generate the EFOV image, wherein the binary pixel maps are blended in a neighborhood of a stitching seam to decrease seam visibility.

14. The method of claim 13, wherein pixels having a high intensity difference between respective medical images are not blended to conserve details and edge sharpness.

15. The method of claim 1, wherein the acquired medical images are ultrasound (US) images, and the plurality of artifacts include at least one member of a group consisting of: speckles, shadows, and multi line acquisition (MLA) seams, or the acquired medical images are computed tomography (CT) images, and the plurality of artifacts include at least one member of a group consisting of: beam hardening, metal artifacts, and photon starvation.

16. The method of claim 1, wherein the plurality of stitching surfaces are calculated so that the stitched medical images form the EFOV image as large as possible based on the received images having arbitrary shape and geometry.

17. The method of claim 1, wherein the received medical images have a dimension selected from a group consisting of: two dimension (2D), three dimension (3D), and four dimension (4D).

18. A system for calculating an extended field of view from medical images, comprising:
a processor; and
a memory in electrical communication with the processor, the memory having stored thereon:
an interface for receiving a plurality of registered acquired medical images of a patient, the medical images having a plurality of imaging artifacts based on the medical imaging modality acquiring the medical images;
an analysis module for analyzing the plurality of medical images to identify locations of the plurality of imaging artifacts within the medical images;
a stitching surface module for calculating a plurality of multi-planar stitching surfaces such that seams connecting therebetween are outside the boundaries of the plurality of imaging artifacts; and
wherein the interface provides an extended field of view image having un-edited imaging artifacts from all stitched medical images.

19. The system of claim 18, further comprising a stitching module for stitching the medical images based on the identified stitching surfaces, each side of the stitching surfaces having retained original pixel values from one of the medical images.

20. The system of claim 18, wherein the received medical images are dynamic four dimensional US images, and the stitching surfaces comprise stitching hyper-surfaces, or the received medical images are multi-channel images, and the EFOV is created from stitching the images with respect to all data channels.

21. A computer program product for computing an extended field of view from medical images, the computer program product comprising:
one or more non-transitory computer-readable storage mediums, and program instructions stored on at least one of the one or more storage mediums, the program instructions comprising:
program instructions for receiving a plurality of registered acquired medical images of a patient, the medical images having a plurality of imaging artifacts based on the medical imaging modality acquiring the medical images;
program instructions for analyzing the plurality of medical images to identify locations of the plurality of imaging artifacts within the medical images;
program instructions for calculating a plurality of multi-planar stitching surfaces such that seams connecting therebetween are outside the boundaries of the plurality of imaging artifacts; and
program instructions for providing an extended field of view (EFOV) image having un-edited imaging artifacts from all stitched medical images.
